(19) United States
(12) Patent Application Publication
(10) Pub. No.: US 2006/0022384 A1
(43) Pub. Date: Feb. 2, 2006

(54) Fluid connector for an automotive cooling system

(75) Inventor: Boney A. Mathew, Clarkston, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Mathson Industries

(21) Appl. No.: 11/190,448

(22) Filed: Jul. 27, 2005

Related U.S. Application Data
(60) Provisional application No. 60/591,684, filed on Jul. 28, 2004.

(51) Int. Cl. H05B 7/00

(52) U.S. Cl. 264/453

(57) ABSTRACT

The subject invention includes a method of molding the tubular spout (24) of the connector (20) for an automotive cooling system. The method includes presenting a mold cavity formed by an interior mold part (36) defining a fluid passageway (28) and a single insert (38) made of steel and extending endlessly and annularly completely about the cavity to present an inner diameter C devoid of a parting line for forming the exterior surface of the spout (24) devoid of a parting line and to present the undercut having a ridge diameter A larger than the inner diameter C and extending completely about the cavity to define the nipple ridge (30) extending radially outwardly from the exterior surface of the spout (24). In order to facilitate the separation of the annular insert (38) from the spout (24), the method includes maintaining an undercut ratio of the ridge diameter A minus the outer diameter B divided by the inner diameter C less than or eight percent. Undercut ratio X=[A−B]/C x≦8%.

### CROSS REFERENCE TO RELATED APPLICATION

This application claims the benefit of application Ser. No. 60/591,684 filed Jul. 28, 2004.

### BACKGROUND OF THE INVENTION

1. Field of the Invention

A tubular spout of a connector for an automotive cooling system.

2. Description of the Prior Art

Such connectors are frequently used to house thermostats and include a spout for receiving a hose for fluid flow. The spout has an inner diameter C for defining a fluid passageway in the spout and an outer diameter B for defining the exterior surface of the spout and a nipple ridge extending annularly about the spout. A hose is forced over the niple ridge and clamped to the exterior surface of the spout. The conector is formed of a plastic material and the mold elements defining the cavity in which the spout is formed define a parting line or rib extending radialy outwardly of the exterior surface of the spout and this partingline in the molded spout can cause leakage between the exterior surface of the spout and the hose clamped to that exterior surface.

### SUMMARY OF THE INVENTION AND ADVANTAGES

The invention provides a spout devoid of such a parting line by extending an insert annularly completely about a cavity to present the inner diameter C devoid of a parting line for forming the exterior surface of the spout devoid of a parting line. The anular insert presents an undercut having a ridge diameter A larger than the inner diameter C and extending completely about the cavity to define the nipple ridge extending radially outwardly from the exterior surface of the spout. The insert moved over the nipple ridge by flexing the nipple ridge into the smaller inner diameter C of the insert.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of the spout side of a connector of the subject invention;

FIG. 2 is a perspective view of the conector of FIG. 1 from the flange side;

FIG. 3 is cross secitonal view of the distal end of the spout of the conector;

FIG. 4 is a cross secitonal view of a mold asembly for molding the spout of the subject invention;

FIG. 5 is a cross sectional view of the spout showing exemplary dimensions;

FIG. 6 is a cross sectional view of the spout showing exemplary dimensions; and

FIG. 7 is an enlarged fragmentary cross sectional view of the spout.

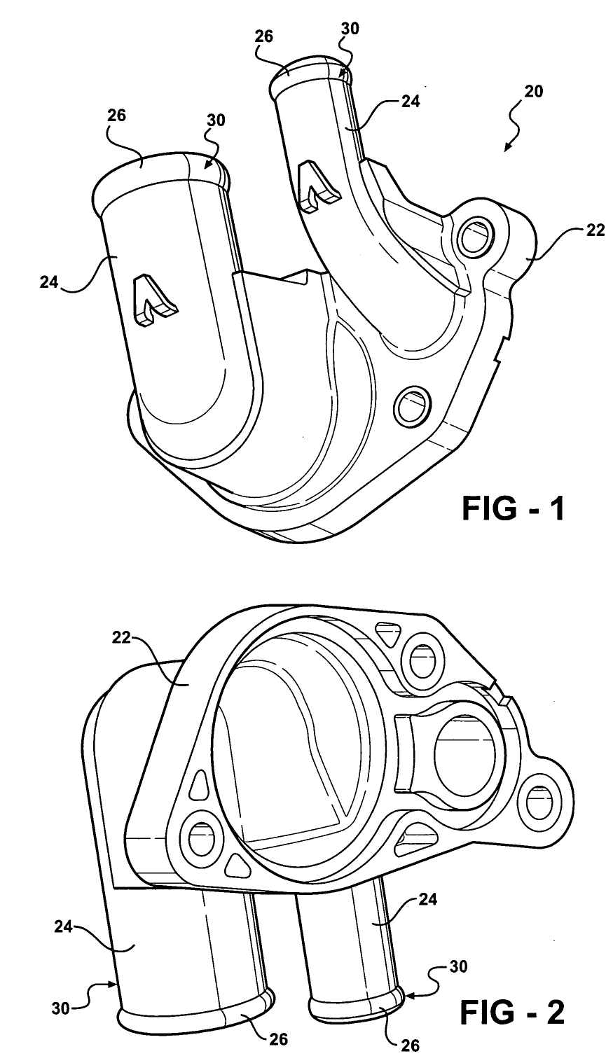

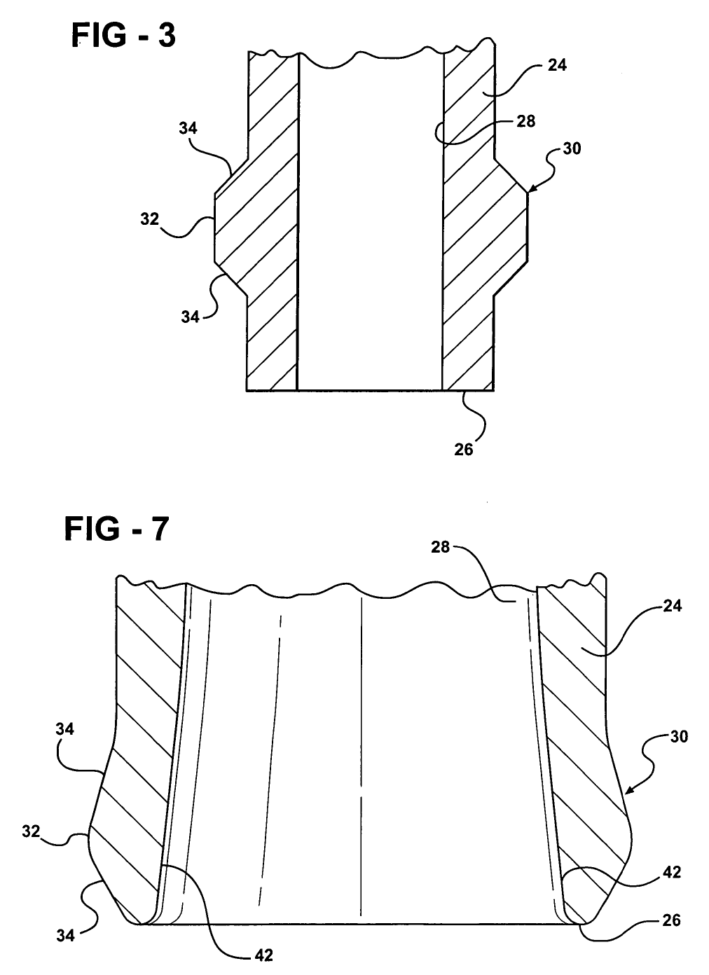

### DETAILED DESCRIPTION OF THE INVENTION

Referring to the Figures, wherein like numerals indicate corresponding elements throughout the several views, a connector 20 is shown generally for an automotive cooling system. The connector 20 includes a flange 22 having bolt holes for connection to a support, such as an automotive engine. The connector 20 also includes a tubular spout 24 extending from the flange 22 to a distal end 26 and defining a passageway 28 extending from an opening in the distal end 26 of the spout 24 for fluid to flow therethough. As illustrated, the connector 20 includes two such spouts 24, one large spout 24 for housing a thermostat and a smaller spout 24 for fluid flow.

As illustrated in FIG. 3, the spout 24 has an inner diameter C defining the fluid passageway 28 in the spout 24 and an outer diameter B defining an annular exterior surface of the spout 24 and a nipple ridge 30 (generally indicated) having a ridge diameter A larger than the exterior surface of the spout 24 and extending annularly about the exterior surface of the spout 24 for receiving a hose. A hose, or the like, can be forced over the nipple ridge and a clamp disposed about the hose to seal the hose to the exterior surface of the spout 24. The spout 24 is molded of a plastic material having a glass filler to form the spout 24 and the spout 24 is normally formed in a cavity defined by a mold assembly that form a parting line or rib of the molded plastic material by flowing into the seam between the two mold elements.

The connector 20 of the subject invention is characterized by the exterior surface of the spout 24 being devoid of such a parting line on the opposite side of the nipple ridge 30 from the distal end 26 with the nipple ridge extending radially outwardly from the exterior surface and extending completely about the exterior surface, whereby a hose disposed over the nipple ridge can be held in tight sealing engagement with a smooth exterior surface of the spout 24 completely about the spout 24 to diminish the possibility of leakage.

Although other shapes may be employed, in the embodiment illustrated, the cross section of the nipple ridge 30 includes a straight top 32 extending between ends and parallel to the exterior surface and diverging straight sides 34 extending from opposite ends of the top to the exterior surface.

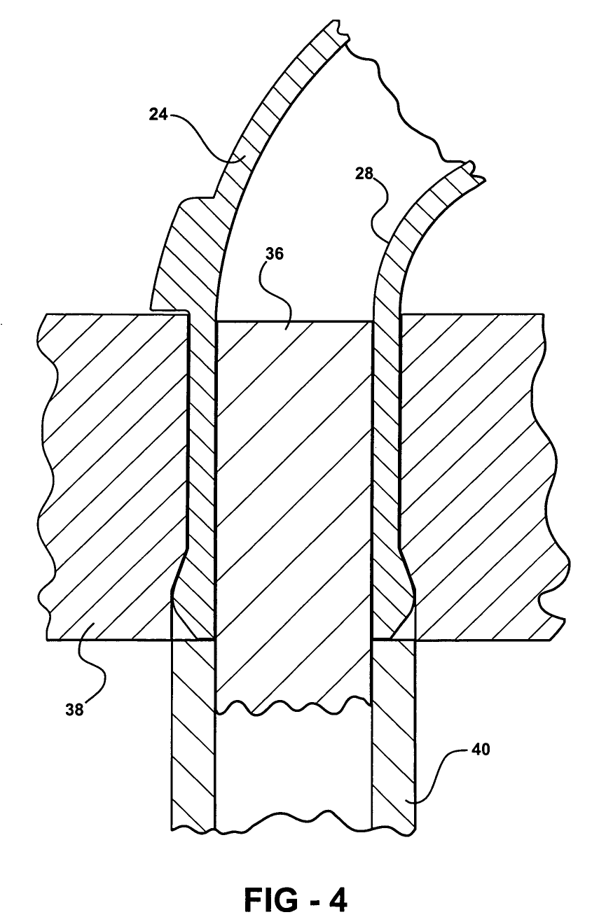

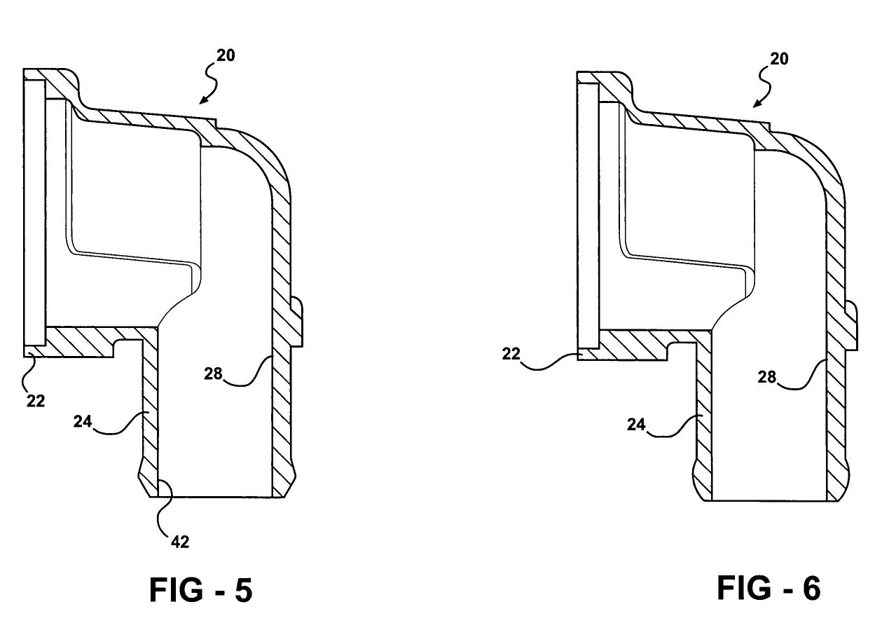

The subject invention includes a method of molding the tubular spout 24 of the connector 20 for an automotive cooling system. As illustrated in FIGS. 3 and 4, the method includes presenting a mold cavity having an inner diameter C for defining the fluid passageway 28 in the spout 24 and an outer diameter B for defining the exterior surface of the spout 24 and an undercut with a ridge diameter A for defining a nipple ridge 30 extending annularly about the spout 24. The cavity is formed by an interior mold part 36 defining the fluid passageway 28 and a single insert 38 made of steel and extending endlessly and annularly completely about the cavity to present the inner diameter C devoid of a parting line for forming the exterior surface of the spout 24 devoid of a parting line and to present the undercut having a ridge diameter A larger than the inner diameter C and extending completely about the cavity to define the nipple ridge 30 extending radially outwardly from the exterior surface of the spout 24.

In accordance with the method, the plastic material is injected into the cavity for forming the spout 24 and after the plastic material solidifies sufficiently, the insert 38 is pulled over the nipple ridge 30 by flexing the nipple ridge 30 into the smaller inner diameter C of the insert 38. A mating mold part 40 extends into the insert 38 to define the outer straight side 34 of the nipple ridge and when removed leaves the annular insert 38 open but with the outer diameter B inside or smaller than the ridge diameter A. Accordingly, the ridge diameter A must flex radially inwardly in order for the insert 38 to be removed from the spout 24.

In order to facilitate the separation of the annular insert 38 from the spout 24, the method includes maintaining an undercut ratio of the ridge diameter A minus the outer diameter B divided by the inner diameter C less than 0.08 or eight percent. Undercut ratio X=[A−B]/C x≦8%.

In order to facilitate the flexing of nipple ridge radially inwardly for removal from the insert 38, the interior mold part 36 presents the cavity with a conically shaped taper 42 extending into the inner diameter C and under the undercut defining the nipple ridge 30. The taper 42 is preferred but not required in all applications. The taper 42 can increase the undercut ratio up to fifteen percent to around nine percent.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

ELEMENT LIST

| Element Symbol | Element Name |
|---|---|
| 20 | connector |
| 22 | flange |
| 24 | spout |
| 26 | distal end |
| 28 | passageway |
| 30 | nipple ridge |
| 32 | straight top |
| 34 | straight sides |
| 36 | interior mold part |
| 38 | insert |
| 40 | mating mold part |
| 42 | taper |

What is claimed is:

1. A method of molding a tubular spout (24) of a connector (20) for an automotive cooling system comprising the steps of;
presenting a cavity having an inner diameter C for defining a fluid passageway (28) in the spout (24) and an outer diameter B for defining the exterior surface of the spout (24) and an undercut for defining a nipple ridge (30) extending annularly about the spout (24),
injecting plastic material into the cavity for forming the spout (24), and
characterized by extending an insert (38) annularly completely about the cavity to present the inner diameter C devoid of a parting line for forming the exterior surface of the spout (24) devoid of a parting line and to present an undercut having a ridge diameter A larger than the inner diameter C and extending completely about the cavity to define the nipple ridge (30) extending radially outwardly from the exterior surface of the spout (24), and
pulling the insert (38) over the nipple ridge (30) by flexing the nipple ridge (30) into the smaller inner diameter C of the insert (38).

2. A method as set forth in claim 1 including maintaining an undercut ratio of the ridge diameter A minus the outer diameter B divided by the inner diameter C less than.

3. A method as set forth in claim 1 including injecting a plastic material containing a glass filler.

4. A method as set forth in claim 1 including presenting the cavity with a conically shaped taper (42) extending into the inner diameter C and under the undercut.

5. A connector (20) for an automotive cooling system comprising;
a tubular spout (24) extending to a distal end (26) and defining a passageway (28) extending from an opening in said distal end (26) of said spout (24) for fluid to flow therethough,
said spout (24) having an inner diameter C defining a fluid passageway (28) in said spout (24) and an outer diameter B defining an annular exterior surface of said spout (24) and a nipple ridge (30) having a ridge diameter A larger than said exterior surface of said spout (24) and extending annularly about said exterior surface of said spout (24) for receiving a hose,
said spout (24) including a plastic material forming said spout (24), and
characterized by said exterior surface of the spout (24) being devoid of a parting line and said nipple ridge (30) extending radially outwardly from said exterior surface and extending completely about said exterior surface.

6. A connector (20) as set forth in claim 5 wherein an undercut ratio of the ridge diameter A minus the outer diameter B divided by the inner diameter C is less than.

7. A connector (20) as set forth in claim 5 including a glass filler in said plastic material.

8. A connector (20) as set forth in claim 5 including a conically shaped taper (42) extending into the inner diameter C from said distal end (26) of said spout (24) and under said nipple ridge (30).

9. A connector (20) as set forth in claim 5 wherein the cross section of said nipple ridge (30) includes a straight top (32) extending between ends and parallel to said exterior surface and diverging straight sides (34) extending from opposite ends of said top to said exterior surface.
